(19) United States
(12) Patent Application Publication
(10) Pub. No.: US 2012/0253696 A1
(43) Pub. Date: Oct. 4, 2012

(54) Methods and apparatus for the inspection of plates and pipe walls

(76) Inventors: Neil Randal Pearson, Carmarthenshire (GB); Simon Andrew Horsfall Packer, Swansea (GB); Robin Harald Priewald, Baldramsdorf (AT)

(21) Appl. No.: 13/175,440

(22) Filed: Jul. 1, 2011

(30) Foreign Application Priority Data
Mar. 29, 2011 (GB) GB1105193.5
Jun. 28, 2011 (GB) GB1110889.1

(51) Int. Cl. G01B 7/34

(52) U.S. Cl. 702/38

(57) ABSTRACT

This invention relates to methods and apparatus for inspecting surfaces such as plates or pipe walls of magnetisable material using magnetic reluctance to gain data about the surfaces being inspected. In a preferred method, a magnetic circuit that passes through at least a magnetising unit and a portion of the surface to be inspected is created. The magnetic reluctance in the magnetic circuit is measured at one or more positions in the circuit. At least one of the measured magnetic reluctance values is incorporated into one or more algorithms. The result of the or each algorithm is recorded or displayed for each magnetic reluctance reading in association with information concerning the position of the or each magnetic reluctance reading on the surface.

This invention relates to methods and apparatus for inspecting plates or pipe walls of magnetisable material and in particular methods and apparatus for using magnetic reluctance to gain data about the plate or pipe wall being inspected. The plates to be inspected may be part of a wall or floor of a storage tank or used for other purposes.

It is known that if the poles of a magnetising means such as a horseshoe magnet or its equivalent (for example a yoke of magnetisable material to which are attached one or more magnets, their polarities being opposite (e.g. one of the magnets having its north pole in contact with the yoke and the other its south pole in contact with the yoke)) are placed in contact with or closely adjacent to a piece of magnetisable material, e.g. a steel plate, or pipe wall, or a plate or pipe wall of ferrous, diamagnetic or paramagnetic material, a magnetic field will flow through the horseshoe magnet, the plate and back to the horseshoe magnet, a so called magnetic circuit. The magnetic circuit can alternatively be generated by use of one or more permanent magnets or one or more electro-magnets. The resistance of the materials in that circuit to the flow of the magnetic field is known as magnetic reluctance. The magnetic reluctance of a magnetic circuit may be measured with a magnetic flux sensor, transducer or similar known measurement means.

The magnetic reluctance in a magnetic circuit is influenced by the geometry of the various elements of the materials through which the circuit passes and the magnetic permeability of those materials.

When discussing horseshoe magnets and equivalent magnets it is generally most convenient to describe them in two dimensions. It will be appreciated that in reality objects are three dimensional, but that for such magnets the two dimensional situation at most positions along length of the third dimension is constant unless described otherwise.

According to the present invention there is provided a method of inspecting plates or pipe walls of magnetisable material characterised in that the method comprises the steps of:

(i) creating a magnetic circuit that passes through at least a magnetising unit and a portion of the plate or pipe wall to be inspected;
(ii) measuring the magnetic reluctance in the magnetic circuit at one or more positions in the circuit;
(iii) incorporating at least one of the measured magnetic reluctance values into one or more algorithms; and
(iv) recording or displaying the result of the or each algorithm for each magnetic reluctance reading in association with information concerning the position of the or each magnetic reluctance reading on surface of plate or pipe walls.

In a particularly preferred embodiment of the present invention, there is at least one air gap between the magnetising unit and the portion of the plate or pipe wall to be inspected.

It is known that at its simplest a magnetic circuit incorporating a horseshoe magnet or an equivalent thereto, a plate or pipe wall of magnetisable material and an air gap between the poles of the magnet and the plate or pipe wall may be considered to be comprised of a yoke, pole 1 and pole 2, the specimen to be inspected, and an air gap 1 between pole 1 and the specimen and an air gap 2 between pole 2 and the specimen. The magnetic reluctance of the circuit be described by the following algorithm where there are two air gaps

R_{circuit}=R_{yoke}+R_{pole 1}+R_{pole 2}+R_{air gap 1}+R_{air gap 2}+R_{specimen}

### Where

R=magnetic reluctance
R_{circuit}=the total reluctance of the magnetic circuit The magnetic reluctance for the whole of the air gap can be approximated by taking one or more reluctance measurements in the air gap and extrapolating from those measurements. A major factor in those extrapolations will be the area over which the or each sensor measures the magnetic reluctance.

The magnetic reluctance of the yoke, pole 1 and pole 2 can be measured or calculated by known techniques before, during or after manufacture of an item of test apparatus. If it is known what thickness the air gaps 1 and 2 will be, the magnetic reluctance of those air gaps can be calculated in a similar fashion by known techniques. Alternatively, the magnetic reluctance of R_{air gap 1} and R_{air gap 2} can be measured by application of the magnetic circuit to a calibrated specimen. Once R_{air gap 1} and R_{air gap 2} are known in controlled conditions an inspection apparatus used to perform the method of the present invention may be used upon plates or pipe walls to be inspected.

In a first preferred method according to the present invention, repeated measurements of the magnetic reluctance (R_{circuit}) of the magnetic circuit are taken as an inspection apparatus used to perform the method of the present invention is moved across the surface of a plate or pipe wall to be inspected, the measured values for R_{circuit} averaged, and the value for R_{specimen} calculated. Once R_{specimen} is known, use of the algorithm

$${R}_{specimen} = \frac{l}{{μ}_{0} {μ}_{r} A}$$

### Where

R_{specimen}=calculated magnetic reluctance
l=the length of the circuit in the specimen;
μ₀=the permeability of free space;
μᵣ=the relative magnetic permeability of the material;
A=the cross-sectional area of the circuit

Allows the average cross sectional area and hence average thickness of the specimen to be calculated if the distance between the poles of the magnetising unit is known and assumptions about the width of the magnetic circuit within the circuit made.

Knowledge of the thickness of the plate or pipe wall being inspected may be useful in itself. In a particularly preferred method according to the present invention, the method of the present invention is combined with a magnetic flux leakage (MFL) (also known as magnetic flux exclusion (MFE), but simply termed magnetic flux leakage hereafter) inspection method of inspecting a plate or pipe wall of magnetisable material. In such an embodiment, the calculated thickness of the a plate or pipe wall may be used to calibrate the apparatus used for the magnetic flux leakage inspection or, more preferably, the data generated by the magnetic flux leakage inspection. The calibration can either be on-line, that is as the inspection proceeds, or off-line, that is applied to the magnetic flux leakage data before, after or before and after it has been gathered. The measurement of the magnetic reluctance can occur simultaneously with the magnetic flux leakage inspection utilising the same magnetic circuit. It will be appreciated that the averaging of a number of magnetic reluctance measurements will serve to cancel, or minimise to an acceptable extent, any effects the presence of discontinuities in the plate or pipe wall being inspected may cause.

Magnetic flux leakage inspection techniques that use a magnetising unit, one or more sensors to detect magnetic flux leakage caused by discontinuities in the plate or pipe wall of magnetisable material being inspected and data analysis means for analysing the data from the sensors are known and will not be discussed in any detail herein. It is, however, a particular advantage of the present invention that the method of the present invention may be performed using essentially the same apparatus as that used for known magnetic flux leakage. This is advantageous because known magnetic flux leakage inspection apparatus can be readily adapted to incorporate the method of the present invention.

According to another particularly preferred method according to the present invention the magnetic reluctance of the circuit R_{circuit} is repeatedly measured and each measurement compared to previous and subsequent measurements. Because the relative magnetic permeability of the air in the air gaps is very small relative to the other materials that the magnetic circuit passes through, any change in the thickness of the air gap has a significant and measurable effect on the magnetic reluctance of the circuit R_{circuit}. This has the effect that an increase in the magnetic reluctance of the circuit R_{circuit} relative to a previous measurement can be correlated to one or both of the air gaps increasing in thickness. Such an increase in thickness is most likely to be due to the presence of a pit or discontinuity in/on the surface of the plate or pipe wall being inspected that is adjacent to the inspection apparatus. A pit or discontinuity in/on the surface of the plate or pipe wall being inspected that is adjacent the inspection apparatus is known as a top surface discontinuity. The location of such top surface discontinuities are recorded together with position information.

It is particularly preferred that the results of this preferred method are combined with the results of a magnetic flux leakage inspection so that the discontinuities identified in the magnetic flux leakage inspection may be identified as top or bottom surface discontinuities. This is possible because magnetic flux leakage inspection methods are known to be able to identify both top surface discontinuities and discontinuities on the surface of the plate or pipe wall distant from the testing apparatus, known as bottom surface discontinuities. Magnetic flux leakage inspection methods are not, however, at all good at distinguishing top and bottom surface discontinuities from each other. To date, manual inspection, or other separate technologies such as ultrasonic testing (UT) or eddy current (EC) probes are required to achieve this. They also need extra electronics and system components over and above those used in magnetic flux leakage inspection apparatus and hence the combined apparatus has increased complexity and cost. According to the present invention there is further provided apparatus for inspecting plates or pipe walls of magnetisable material characterised in that the apparatus is comprised of:

(i) a magnetising unit suitable for creation of a magnetic circuit through the magnetising unit and the plate or pipe wall;
(ii) measurement means for measuring the magnetic reluctance in the magnetic circuit;
(iii) data processing means; and
(iv) data storage and or display means.

Most preferably the apparatus further comprises a frame supporting the magnetising means, the frame being so configured that the magnetising means is held a predetermined distance from the surface of the plate or pipe wall to be inspected. Most preferably, the frame is provided with one or more wheels rollers or similar means to allow the frame to move smoothly across the surface of the plate or pipe wall to be inspected.

It is preferred that the magnetising means is comprised of a yoke of magnetisable material and two poles which are attached to the yoke, each pole comprising at least a magnet, which is a permanent magnet, preferably a rare earth magnet, or an electro-magnet, and having a pole face at the opposite end of the pole to the interface between the pole and the yoke. The apparatus is preferably so constructed that when the frame is placed upon the surface of a plate or pipe wall to be inspected each pole face is adjacent to the surface of the plate or pipe wall to be inspected and separated therefrom by an air gap.

It is most preferred that the measurement means for measuring the magnetic reluctance of the magnetic circuit are located within at least one of the air gaps. It is particularly preferred that the or each pole face defines a recess within which at least one magnetic reluctance measuring means may be located. The magnetic reluctance measuring means may be any suitable means including indirect measuring means, such as the most preferred measuring means which are flux density sensors which give results which may be used to calculate the magnetic reluctance. The particular benefit of locating the magnetic reluctance measuring means within the recess is that the pole face will protect the or each magnetic reluctance measuring means from damage due to inadvertent contact with the surface of the plate or pipe wall to be inspected or material located on the surface of the plate or pipe wall. The size and shape of the recess is most preferably chosen as one that is going to have minimum effect on the magnetic flux passing between the pole and the plate or pipe wall. It is most preferred that the recess is a corner rebate, a chamfer or a similar shape.

In an alternative preferred embodiment of the present invention the magnetising unit includes at least one pole which is comprised of a at least a pole piece and the pole face of that pole is comprised of at least two pole face portions, one pole face portion being more remote from the interface between the pole and the yoke than the other pole face portions. Where the pole is comprised of a magnet and a pole piece, the magnet is between the yoke and the pole piece.

In one embodiment of the present invention it is preferred that the pole piece is a single element, there are two pole face portions joined by a side face, and at the junction of the side face and the pole face portion nearest the interface between the pole and the yoke there is a groove extending towards the interface between the pole and the yoke. In this embodiment the two pole face portions are preferably substantially planar and substantially parallel to each other, the side wall joining the pole face portions is substantially perpendicular to the two pole face portions, and the means for measuring the magnetic reluctance is fixed to the pole face portion nearest the interface between the pole and the yoke.

In an alternative embodiment of the present invention, in which the pole piece is comprised of first and second pole elements, the first and second pole elements being separated by a gap extending from the interface between the pole and the yoke or the interface between the pole piece and the magnet to the pole faces, the ends of the first and second pole elements form the pole face portions and the means for measuring the magnetic reluctance is fixed to the pole face portion nearest the interface between the pole and the yoke.

In these embodiments, the measurement means for measuring the magnetic reluctance of the magnetic circuit are located within at least one of the air gaps, and the or each pole that is associated with a measurement means is so configured as to cause the flow of the magnetic flux between the pole and the plate or pipe wall to pass through at least two discrete magnetic fields. The measurement means is located so as to measure the magnetic reluctance in one of those fields. Most preferably the configuration of the pole is such that the strength of at least one of the discrete magnetic fields is significantly smaller than the other discrete magnetic fields, and the measurement means measures the magnetic reluctance in the or one of the smaller strength magnetic fields.

To achieve the discrete magnetic fields, it is preferred in one embodiment that the or each pole that is associated with a measurement means defines a corner rebate which includes a notch or groove between the two faces that define the rebate. The groove has the physical effect that the pole has two pole faces that face the plate or pipe wall, one of which is further from the plate or pipe wall than the other. The groove can be “U” or “V” shaped and has a dimension (measured in the direction of the shortest line that goes between the yoke and the plate or pipe wall and passes through the groove, the “yoke-plate direction”) greater than zero, and preferably equal to or greater than 2 mm. The width of the groove in a direction perpendicular to the yolk-plate direction and the longitudinal axis of the groove is preferably between 1 and 10 mm and most preferably between 4 to 6 mm.

Alternatively, the discrete magnetic fields can be achieved by forming the pole from a pair of pole elements that are separated from each other by an air gap. Preferably the air gap is between 1 and 10 mm wide, and most preferably between 4 and 6 mm wide. The pole pieces can be of different dimensions, those dimensions affecting how big an air gap there is between the pole faces and the plate or pipe wall, and/or the area of the pole face each pole element has. Other methods of channelling the magnetic field within the pole and between the pole faces and the plate or pipe wall can be adopted to achieve the same effect. Such means may include use of poles comprised of more than one material, each material having different magnetic properties.

An advantage of the embodiments of the present invention that include creating discrete magnetic fields each with their own strength is that one of the discrete magnetic fields can be designed so as to be of a suitable strength to be optimal for the operation of the measurement means.

In at least the embodiments of the present invention that include creating discrete magnetic fields each with their own strength it is preferred that the measurement means for measuring the magnetic reluctance of the magnetic circuit are located as close to the surface of the plate or pipe wall as possible. It is most preferred that when the apparatus of the present invention is positioned for use in connection with a plate or pipe wall that the part of the measurement means closest to the surface of the plate or pipe wall is substantially the same distance from the plate or pipe wall as that part of the pole that is closest to the plate or pipe wall.

Different distances of the measurement means from the plate or pipe wall are possible in other embodiments, the distance being calculated so as to achieve the highest range of signals being generated by the measurement range (the peak to peak range). Furthermore, it is preferred that the measurement means are placed in the centre of the pole face with which it/they is/are associated. This minimises interference in the readings by the measurement means by any edge effects of the magnetic field within which the measurement means are situated and form the adjacent magnetic field from the other pole face of the pole. In some embodiments of the present invention it is preferred to have the null field of the X component of the magnetic field that the measurement means is measuring set to zero (i.e. magnetic flux lines travel perpendicular between the surface of the pole piece and the surface of the plate or pipe wall being inspected when no top surface defects are present), so there is minimal offset of the sensors when at a 90 degree angle, this renders the strength of the field is less important.

In some preferred embodiments of the present invention the or each of the magnet reluctance measurement means are orientated so as to measure only a portion or vector of the magnetic flux in the air gaps. This approach has particular advantages in that it is possible to use commercially available measurement means in magnetic flux fields that would, if the measurement means were orientated so as to measure the whole of the magnetic flux directly, saturate the measurement means so as to render it inoperative. It is also advantageous because if only a portion or vector of the magnetic flux is measured, any change in the magnetic flux caused by the measurement means passing over a discontinuity in the plate or pipe wall is a greater proportion of the measured magnetic flux than if the whole of the magnetic flux were being measured.

The orientation of the measurement means may be measured relative to x, y, and z axis where the z axis is parallel to the expected orientation of the magnetic flux lines passing through the air gap assuming that there is no discontinuity in the plate or pipe wall, the x axis is perpendicular to the z axis and parallel to the expected orientation of the magnetic flux lines passing through the plate or pipe wall between the poles of the magnetising unit, and the y axis is perpendicular to the x and z axes. In a particularly preferred embodiment of the present invention the or each magnetic reluctance measurement means is orientated so as to measure a magnetic flux vector at an angle to the z axis, preferably that angle will be in the range of 45° to 90° and most preferably 80° to 85° to the z axis. The orientation of the or each magnetic reluctance measurement means to the x and y axes may be chosen to provide the optimal measurements.

The apparatus of the present invention will most preferably further comprise magnetic flux leakage measuring means. Those magnetic flux leakage measuring means are preferably located in a position where the optimal magnetic flux leakage measurements may be obtained. Most preferably, magnetic flux leakage measuring means are located between two of the poles in a known fashion.

In apparatus according to the present invention the magnetic reluctance measurement means may be set out in a linear array orientated in a direction perpendicular to both the expected direction of travel of the apparatus across the surface of the plate or pipe wall to be inspected, and, at any given position along the length of the array, perpendicular to the a line normal to the surface of the plate or pipe wall to be inspected at that position.

Inspection apparatus according to the present invention will be further described and explained by way of an example with reference to the accompanying drawings in which:

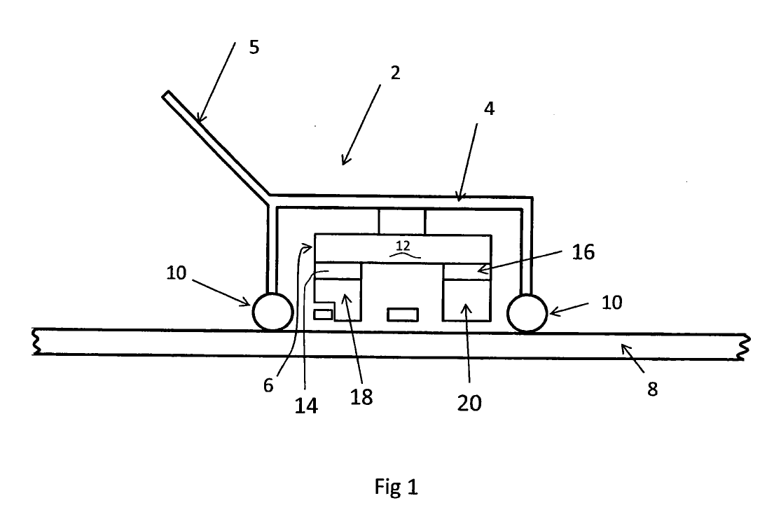

FIG. 1 shows a schematic side view of an example of a first inspection apparatus according to the present invention;

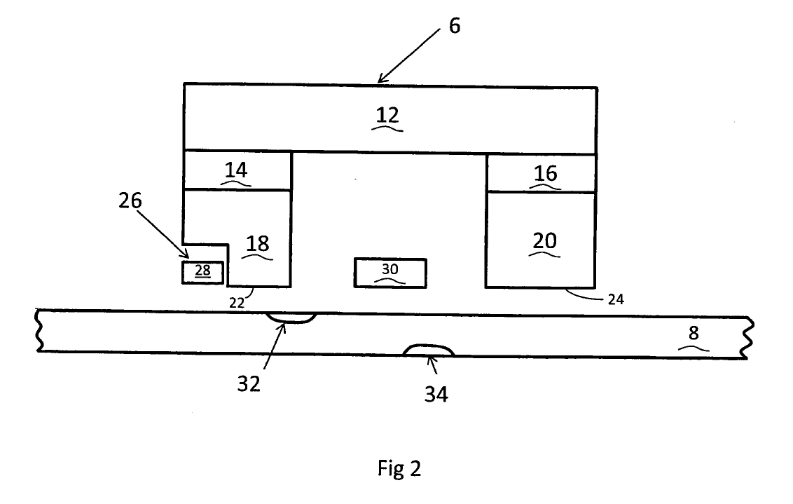

FIG. 2 shows an enlarged view of the magnetising unit of FIG. 1;

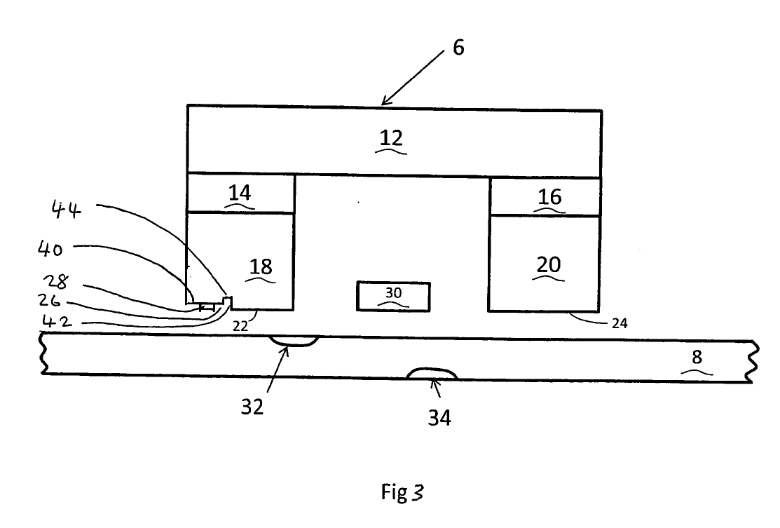

FIG. 3 shows an enlarged view of an example of a second magnetising unit according to the present invention;

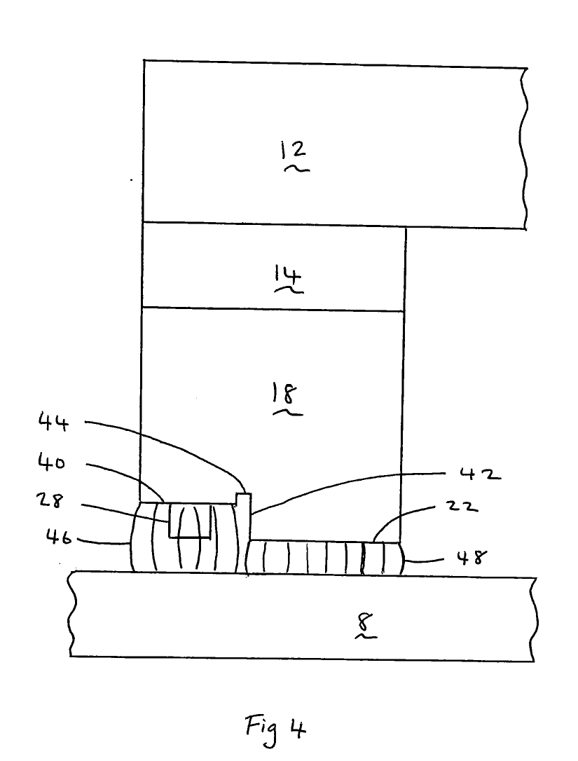

FIG. 4 shows a detail of the magnetising unit of FIG. 3; and

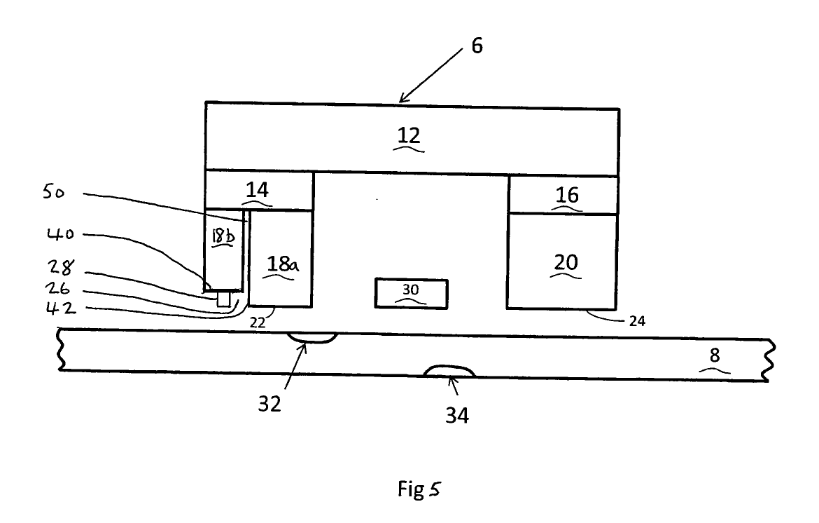

FIG. 5 shows an enlarged view of an example of a third magnetising unit according to the present invention.

With reference to FIG. 1, an inspection apparatus (2) for inspecting plates or pipe walls of magnetisable material is comprised of a frame (4) with a handle (5) on which is mounted a magnetising unit (6). The frame (4) is supported on the surface of a plate (8) to be inspected via wheels (10).

With reference to FIG. 2, the magnetising unit (6) is comprised of a yoke (12), two permanent magnets (14, 16), and two pole pieces (18,20) which are associated with the permanent magnets (14, 16). The permanent magnets are rare earth magnets and the yoke (12) and the poles (18, 20) are both made of steel. The poles (18, 20) are present to protect the magnets (14, 16) from impacting or scraping on the surface of plate (8). The magnetising unit (6) is held on the frame (4) (by means not shown) in such a position that pole faces (22, 24) of the poles (18, 20) are separated from the surface of the plate (8) by a small air gap. Typically this air gap will be around 4 mm in thickness.

The pole (18) includes a corner rebate (26) which is of suitable dimensions to allow one or more magnetic reluctance measuring means (28) to be mounted in the rebate. The mounting of the magnetic reluctance measuring means (28) in the rebate (26) is desirable because the body of the pole (18) protects the magnetic reluctance measuring means (28) from impact with or scraping on the surface of the plate (8). In other embodiments of the present invention the rebate (26) can be located elsewhere on pole face (22) and additionally, or alternatively, there can be a rebate in poll face (24) in which are mounted additional or alternative magnetic reluctance measuring means (28).

Mounted between the poles (18, 20) (by means not shown) are one or more magnetic flux density sensors such as Hall effect sensors (30) configured so as to be able to detect any magnetic flux leakage from the portion of the magnetic circuit that passes through the plate (8) adjacent the magnetic flux density sensors (30).

In use, the inspection apparatus (2) preferably moves across the surface of the plate (8) causing the magnetic circuit created by the magnetising unit and passing through the portion of plate (8) beneath and between the poles (18, 20) to move through the plate (8) at the same time, and measurements of magnetic reluctance of the magnetic circuit are repeatedly taken by magnetic reluctance measuring means (28). At the same time, the output from the magnetic flux density sensors (30) is measured.

When the pole face (22) passes over a representative discontinuity (32) on the surface of the plate (8) adjacent the inspection apparatus (2) the thickness of the air gap between the pole face (22) and the surface of the plate (8) increases and the magnetic reluctance of the magnetic circuit increases This leads to an increase in measured value by the magnetic reluctance measuring means (28). When the magnetic flux density sensors (30) pass over the discontinuity (32) a leakage of magnetic flux from the plate (8) is detected by the magnetic flux density sensors (30). In contrast, when the pole face (22) passes over a representative discontinuity (34) on the surface of the plate (8) distant from the inspection apparatus (2) the thickness of the air gap between the pole face (22) and the surface of the plate (8) is unchanged and the magnetic reluctance of the magnetic circuit is substantially unchanged. This leads to little or no increase in measured value by the magnetic reluctance measuring means (28). When the magnetic flux density sensors (30) pass over the discontinuity (34) a leakage or loss of magnetic flux from the plate (8) is detected by the magnetic flux density sensors (30). Because of this difference, comparison of the outputs obtained from the magnetic reluctance measuring means (28) and the magnetic flux density sensors (30) for a particular position allows the surface on which a discontinuity is located to be determined.

With reference to FIG. 3, and using the same reference numerals where appropriate, a second example of a magnetising unit (6) is comprised of a yoke (12), two permanent magnets (14, 16), and two pole pieces (18, 20) which are associated with the permanent magnets (14, 16). The permanent magnets are rare earth magnets and the yoke (12) and the pole pieces (18, 20) are both made of steel. The pole pieces (18, 20) are present to protect the magnets (14, 16) from impacting or scraping on the surface of plate (8). The magnetising unit (6) is held on the frame (4) (by means not shown) in such a position that pole faces (22, 24) of the pole pieces (18, 20) are separated from the surface of the plate (8) by a small air gap. Typically this air gap will be around 4 mm in thickness.

The pole piece (18) includes a corner rebate (26) which is of suitable dimensions to allow one or more magnetic reluctance measuring means (28) to be mounted in the rebate. Between the faces that define the rebate (40, 42) is a groove (44). The groove (44) has the effect of dividing the magnetic flux flowing through the pole piece (18) so that a portion flows through the face (40) in the rebate and a portion through the face (22). In FIG. 4 the magnetic fields that are a result of the flow of the magnetic flux between the pole piece (18) and the plate or pipe wall (8) are represented by field lines (46) and (48) respectively. The air in the air gap between the faces (40) and (22) has a significantly higher magnetic reluctance than the material from which the pole piece (18) is made and accordingly, the majority of the magnetic flux will flow through pole magnetic field (48). A smaller amount of flux will flow through magnetic field (46) rendering the size or strength of the magnetic field (46) more suitable for measurement by the magnetic reluctance measuring means (28).

The mounting of the magnetic reluctance measuring means (28) in the rebate (26) is desirable because the body of the pole (18) protects the magnetic reluctance measuring means (28) from impact with or scraping on the surface of the plate (8).

With reference to FIG. 5, and using the same reference numerals where appropriate, a third example of a magnetising unit (6) is comprised of a yoke (12), two permanent magnets (14, 16), and three pole pieces (18a, 18b, 20) which are associated with the permanent magnets (14, 16). The permanent magnets are rare earth magnets and the yoke (12) and the pole pieces (18a, 18b, 20) are made of steel. The pole pieces (18a, 18b, 20) are present to protect the magnets (14, 16) from impacting or scraping on the surface of plate (8). The magnetising unit (6) is held on the frame (4) (by means not shown) in such a position that pole faces (22, 24) of the pole pieces (18a, 20) are separated from the surface of the plate (8) by a small air gap. Typically this air gap will be around 4 mm in thickness.

The pole pieces (18a, 18b) extend different distances from the magnet (14) toward plate (8) with pole piece (18b) extending less distance than pole piece (18a). The pole pieces (18a) and (18b) are separated by an air filled gap (50). In alternative embodiments of the present invention the gap (50) can be filed by an alternative material with a high magnetic reluctance.

The different dimensions of the pole pieces (18a) and (18b) causes the creation of an effective rebate (26) in which one or more magnetic reluctance measuring means (28) are mounted. The arrangement of the pole pieces (18a) and (18b) and the air gap (50) between them has the effect of dividing the magnetic flux flowing around the magnetic circuit (passing through magnet (16), yoke (12), magnet (14), pole pieces (18a) and (18b), plate (8), and pole (20)) so that a portion flows through pole piece (18a) and a portion through pole piece (18b). This has the same effect as illustrated in FIG. 4 discussed above.

The mounting of the magnetic reluctance measuring means (28) on pole piece (18b) is also desirable because the body of the pole piece (18a) protects the magnetic reluctance measuring means (28) from impact with or scraping on the surface of the plate (8).

1. A method of inspecting plates or pipe walls of magnetisable material characterised in that the method comprises the steps of:
(i) creating a magnetic circuit that passes through a magnetising unit, a portion of the plate or pipe wall, and at least two air gaps between the magnetising unit and the plate or pipe wall;
(ii) measuring the magnetic reluctance of at least one of the air gaps;
(iii) incorporating at least one of the measured magnetic reluctance values into one or more algorithms; and
(iv) recording or displaying the result of the or each algorithm for each magnetic reluctance reading in association with information concerning the position of the or each magnetic reluctance reading on surface of plate or pipe wall.

2. The method of inspecting a plate or pipe wall of magnetisable material according to claim 1 in which the magnetic reluctance is measured in a plurality of positions in at least one of the air gaps.

3. The method of inspecting a plate or pipe wall of magnetisable material according to claim 1 in which the or peach algorithm includes a value for the magnetic reluctance of the magnetising unit, the magnetic reluctance of one or all air gaps is measured and the magnetic reluctance of the portion of the plate or pipe wall through which the magnetic circuit passes may be calculated.

4. The method of inspecting a plate or pipe wall of magnetisable material according to claim 3 in which the calculated magnetic reluctance of the portion of the plate or pipe wall through which the magnetic circuit passes is used to calculate the average thickness of the portion of the plate or pipe wall through which the magnetic circuit passes.

5. The method of inspecting a plate or pipe wall of magnetisable material according to claim 4 in which the calculated average thickness of the inspected plate or pipe wall in a particular region is used to calibrate or enhance the results of a magnetic flux leakage inspection on that region of the plate or pipe wall.

6. The method of inspecting a plate or pipe wall of magnetisable material according to claim 1 in which the magnetising unit is moved across the surface of the plate or pipe wall and measurement of the magnetic reluctance is repeated at predetermined intervals.

7. The method of inspecting a plate or pipe wall of magnetisable material according to claim 1 in which the magnetic reluctance of the air gap is measured at repeated intervals across the plate or pipe wall and an algorithm is used to compare the magnetic reluctance measurements with each other and identify any increase or decrease in the measured magnetic reluctance of the air gap across the surface of the plate or pipe wall.

8. The method of inspecting a plate or pipe wall of magnetisable material according to claim 7 in which the algorithm includes functions that allow any measured increase or decrease in the magnetic reluctance to be used to calculate the size of any increase or decrease in the thickness of the air gap.

9. The method of inspecting a plate or pipe wall of magnetisable material according to claim 8 in which the data concerning the calculated increase or decrease of the thickness of the air gap and the position of that increase or decrease is combined with the results of magnetic flux leakage inspection of the plate or pipe wall for the same position to determine the top or bottom surface nature of any discontinuity in the plate or pipe wall.

10. Apparatus for inspecting plates or pipe walls of magnetisable material characterised in that the apparatus is comprised of:
(i) a magnetising unit suitable for creation of a magnetic circuit through the magnetising unit and at least one air gap between the magnetising unit and the plate or pipe wall;
(ii) measurement means for measuring the magnetic reluctance in at least one air gap;
(iii) data processing means; and
(iv) data storage and or display means.

11. The apparatus according to claim 10 in which the means for measuring the magnetic reluctance is in the air gap and orientated to measure only a proportion of the magnetic flux density.

12. The apparatus according to claim 11 in which the means for measuring the magnetic reluctance measures the magnetic flux vector at an angle in the range of 45° to 90° to the expected direction of the magnetic flux lines of the magnetic field passing through the at least one air gap.

13. The apparatus according to claim 12 in which the angle is in the range of 80° to 85° to the expected direction of the magnetic flux lines of the magnetic field.

14. The apparatus according to claim 10 in which the magnetising unit is comprised of a yoke of magnetisable material and two poles which are attached to the yoke, at least one pole or the yoke comprising at least one magnet, and both poles having a pole face at the opposite end of the pole to the interface between the pole and the yoke, and in which the apparatus is so constructed that the yoke is supported on a frame so that when the frame is placed upon the surface of the plate or pipe wall to be inspected each pole face is adjacent to the surface of the plate or pipe wall to be inspected and separated therefrom by the at least one air gap.

15. The apparatus according to claim 14 in which at least one of the pole faces at least partially defines a recess suitably dimensioned to allow one or more magnetic reluctance measurement means to be fixed within the recess.

16. The apparatus according to claim 15 in which at least one recess is a corner rebate.

17. The apparatus according to claim 14 in which at least one pole is comprised of a at least one pole piece and the pole face of that pole is comprised of at least two pole face portions, one pole face portion being more remote from the interface between the pole and the yoke than the other pole face portions.

18. The apparatus according to claim 17 in which the pole is comprised of a magnet and a pole piece, the magnet being between the yoke and the pole piece.

19. The apparatus according to claim 17 in which the pole piece is a single element, there are two pole face portions joined by a side face, and at the junction of the side face and the pole face portion nearest the interface between the pole and the yoke there is a groove extending towards the interface between the pole and the yoke.

20. The apparatus according to claim 19 in which the two pole face portions are substantially planar and substantially parallel to each other, the side wall joining the pole face portions is substantially perpendicular to the two pole face portions, and the means for measuring the magnetic reluctance is fixed to the pole face portion nearest the interface between the pole and the yoke.

21. The apparatus according to claim 17 in which the pole piece is comprised of first and second pole elements, the first and second pole elements being separated by a gap extending from the interface between the pole and the yoke or the interface between the pole piece and the magnet to the pole faces, the ends of the first and second pole elements forming the pole face portions and the means for measuring the magnetic reluctance is fixed to the pole face portion nearest the interface between the pole and the yoke.

22. The apparatus according to claim 10 in which the apparatus further comprises a magnetic flux leakage measurement means.
